(19) United States
(12) Patent Application Publication
(10) Pub. No.: US 2014/0376680 A1
(43) Pub. Date: Dec. 25, 2014

(54) Containment Sump Ceramic Drain Plug

(71) Applicant: AREVA Inc., Lynchburg, VA (US)

(72) Inventor: Dilip K. Rao, San Jose, CA (US)

(73) Assignee: AREVA Inc., Lynchburg, VA (US)

(21) Appl. No.: 14/294,367

(22) Filed: Jun. 3, 2014

Related U.S. Application Data
(60) Provisional application No. 61/839,042, filed on Jun. 25, 2013.

(51) Int. Cl. G21C 9/00; F16K 17/38

(52) U.S. Cl. CPC G21C 9/00; F16K 17/383
USPC 376/347; 137/74

(57) ABSTRACT

The present invention provides a drain plug assembly that prevents significant quantities of corium from entering the drain line. By protecting the drain line, essentially no high-activity fission products would be released to the reactor building or the environment during a severe accident. The ceramic drain plug assembly includes a drain plug base and a drain plug supported by a steel pedestal. The lower surface of the plug has a spherical shape such that the plug can be positioned within the base to block access to the drain opening provided in a central portion of the base. During normal operation conditions, the plug is retained above the base by the pedestal. During a severe accident, when corium comes into contact with the pedestal, it will melt rapidly and the drain plug will drop by gravity, effectively closing the sump drain opening and preventing the flow of corium into the drain line.

### CROSS-REFERENCE TO RELATED APPLICATIONS

This patent application claims the benefit of U.S. Provisional Patent Application No. 61/839,042 filed on Jun. 25, 2013, which is incorporated herein by reference in its entirety.

### BACKGROUND OF THE INVENTION

1. Field of the Invention

The present invention relates to a device and method for collecting a reactor melt or reactor meltdown products from a reactor pressure vessel, and, more particularly, the present invention relates to a device and method for automatically closing a containment building sump to drain line in the event of a reactor meltdown.

2. Description of the Related Art

In a typical commercial nuclear power plant, the reactor core is generally placed in a vessel. Nuclear fuel is positioned and retained within the reactor, and coolant (water) is pumped over the fuel to remove heat generated by the chain reaction fission processes that take place within the core and the fuel elements contained therein. The energy (heat) removed by the coolant is used to produce steam that is fed into a turbine to generate electricity. In the case of a pressurized water reactor, there is an additional heat transfer process between the coolant passing through the core and a secondary side loop that includes the turbine.

There are numerous, redundant safety features required to be included nuclear reactor. For example, emergency core cooling systems are provided in the event of a failure of the normal core cooling system (reactor coolant system). These systems include pumps, valves, heat exchangers, tanks, and piping that are specifically designed to remove residual heat from the reactor core. For boiling water reactors, reactor coolant and other fluids released to the drywell following a loss-of coolant accident flow into the pressure suppression pool, which collects reactor coolant and other fluids and serves as the water source to support long-term recirculation for the functions such as residual heat removal and emergency core cooling, The sump is located in the floor of the drywell to capture virtually all fluids that are released inside the drymelt. The sump collects reactor coolant and other fluids from normal and abnormal leak-offs. Piping and pumps are connected to the sump to allow the fluid captured therein to be transferred to the reactor building for processing by the Liquid Radwaste System.

In the hypothetical situation of a beyond design basis event or a severe at a nuclear plant, with safety systems partially or totally incapacitated, the reactor core could melt through the reactor vessel, resulting in the loss of reactor vessel integrity. While this scenario is extremely unlikely to occur, in such event the r often reactor core (known as “corium”) would penetrate the reactor vessel bottom head and flow to the floor of the drywell. Any corium flowing to the containment sump could enter the drain line and cause it to fail because the temperature of molten corium is significantly higher than the melting point temperature of the drain line material. Drain line failure would result in opening a pathway for fission products to exit the containment and eventually be released to the environment. Containment integrity would be lost.

The present invention provides a safeguard against such a disaster.

### SUMMARY OF THE INVENTION

The present invention provides a drain plug assembly that prevents significant quantities of corium from entering the drain line. By protecting the drain line, essentially no high-activity fission products would be released to the reactor building or the environment during a severe accident.

In the hypothetical situation of a severe accident at a nuclear plant, the reactor core could melt through the reactor vessel and flow to the floor of the containment. Any corium flowing to the sump could enter the drain line and cause the line to melt because the corium temperature would typically be approximately 1000° C. (1800° F.) higher than the melting point temperature of the drain line material (carbon steel). Drain line failure would result in opening a pathway for fission product aerosols to exit the containment and eventually be released to the environment.

To prevent corium formed during a severe accident from entering the containment drain line, a ceramic drain plug assembly is provided. The ceramic drain plug assembly includes a drain plug base and a drain plug supported by a steel pedestal. A number of dowel pins could also be used in place of the pedestal. The lower surface of the plug and the upper surface of the base have corresponding profiles such that the plug can be positioned within the base to block access to the drain opening provided in a central portion of the base. During normal operation conditions, the plug is retained above the base by the pedestal. During a severe accident, when corium at temperatures between 2400° C. and 2800° C. (˜4300° F. and 5000° F.) comes into contact with the pedestal, it will melt rapidly and the drain plug will drop by gravity, effectively closing the sump drain opening and preventing the flow of corium into the drain line.

### DESCRIPTION OF THE DRAWINGS

The present invention is described with reference to the accompanying drawings, which illustrate exemplary embodiments and in which like reference characters reference like elements. It is intended that the embodiments and figures disclosed herein are to be considered illustrative rather than restrictive.

FIG. 1 shows the intact drain line configuration for a typical Mark II containment schematic.

FIG. 2 shows the expected flow patterns of corium and aerosols during a severe accident.

FIG. 3 shows an exploded view of a drain plug assembly of the present invention.

FIGS. 4A and 4B illustrate plan and side cross-sectional views, respectively, of the normal position of the drain plug assembly of FIG. 3.

FIGS. 5A and 5B illustrate plan and side cross-sectional views, respectively, of the accident position of the drain plug assembly of FIG. 3.

FIGS. 6A, 6B, and 6C illustrate plan, side cross-sectional, and isometric views, respectively, of the base of the drain plug assembly of FIG. 3.

FIGS. 7A, 7B, and 7C illustrate plan, side cross-sectional, and isometric views, respectively, of the drain plug of the drain plug assembly of FIG. 3.

FIGS. 8A, 8B, and 8C illustrate plan, side cross-sectional, and isometric views, respectively, of the consumable pedestal of the drain plug assembly of FIG. 3.

### DETAILED DESCRIPTION OF THE INVENTION

The present invention provides a drain plug assembly 1 that prevents significant quantities of corium from entering the containment sump drain line 101. By protecting the drain line 101, essentially no high-activity fission products would be released to the reactor building or the environment during a severe accident.

The discussion herein is focused on BWR Mark II containment drywells. However, the concept is sufficiently broad that it is independent of containment type and could be implemented at other nuclear plant containments as well.

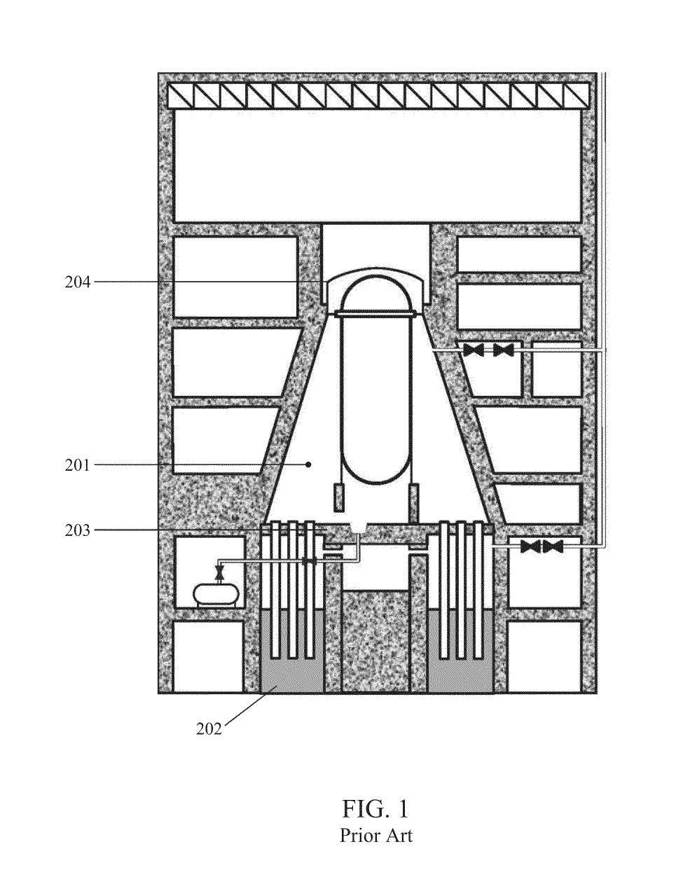

The Mark II primary containment includes a steel dome head and either a post-tensioned or reinforced concrete wall standing on a base mat of reinforced concrete. A drywell 201, in the form of a frustum of a cone or a truncated cone, is located directly above the suppression pool 202. The suppression chamber is cylindrical and separated from the drywell by a reinforced concrete slab 203. The drywell is topped by an elliptical steel dome called a drywell head 204. The drywell atmosphere is vented into the suppression chamber through a series of downcomer pipes penetrating and supported by the drywell floor. FIG. 1 shows the intact drain line configuration for a typical Mark II containment schematic.

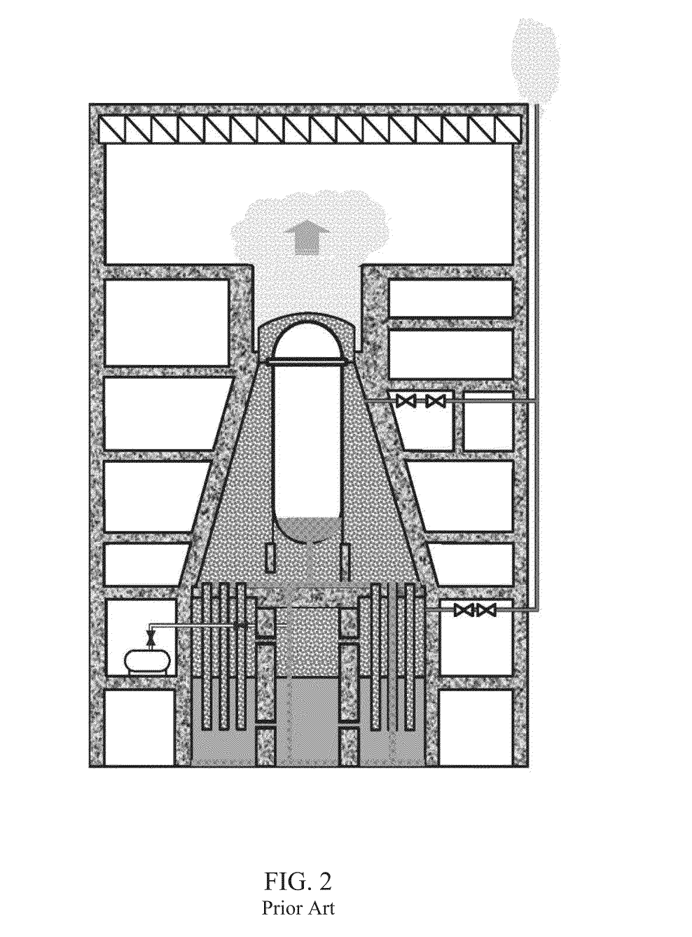

Corium becomes a liquid at temperatures between 2400° C. and 2800° C. Because the melting point of carbon steel or stainless steel (the material of the drywell drain line) is around 1400° C., molten corium would melt the steel, resulting in failure of the drain line. FIG. 2 shows the expected flow patterns of corium and aerosols during a severe accident.

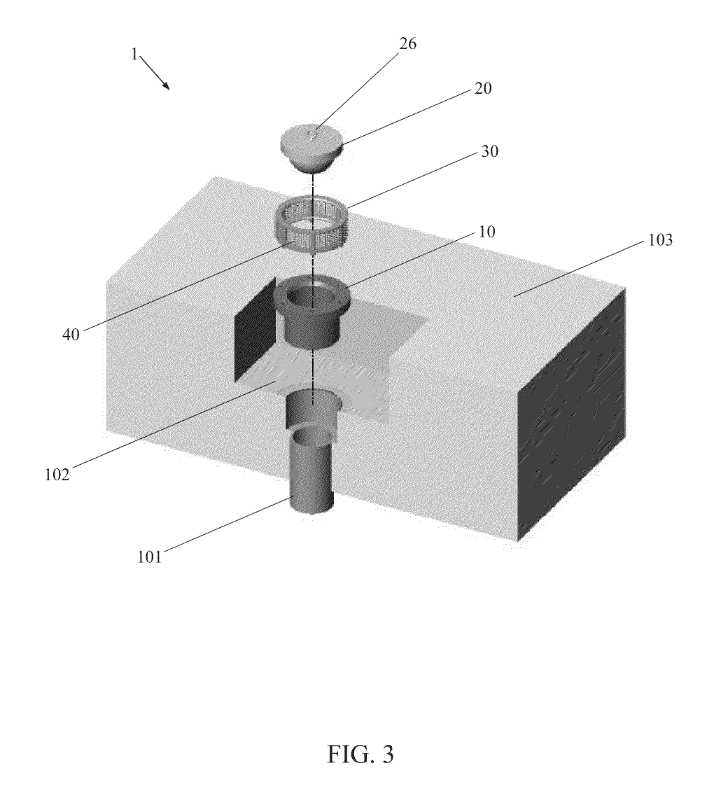

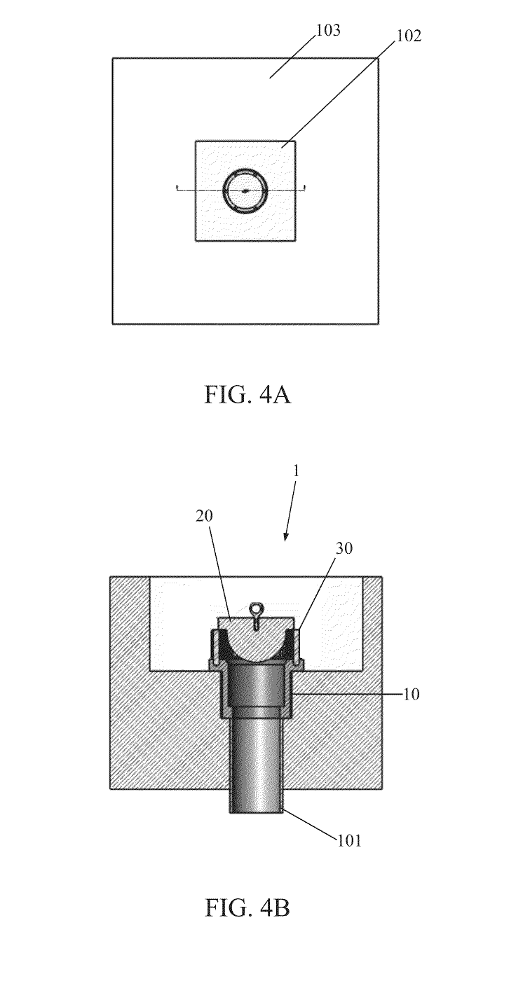

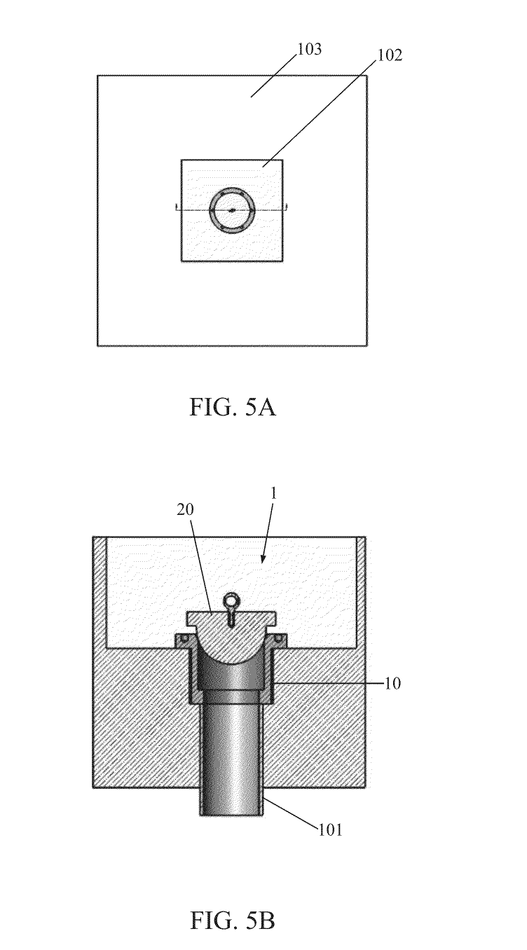

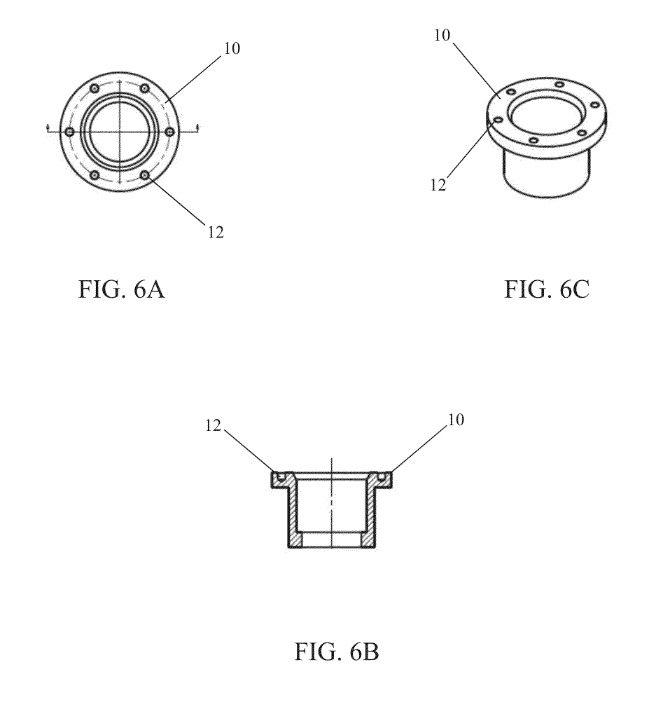

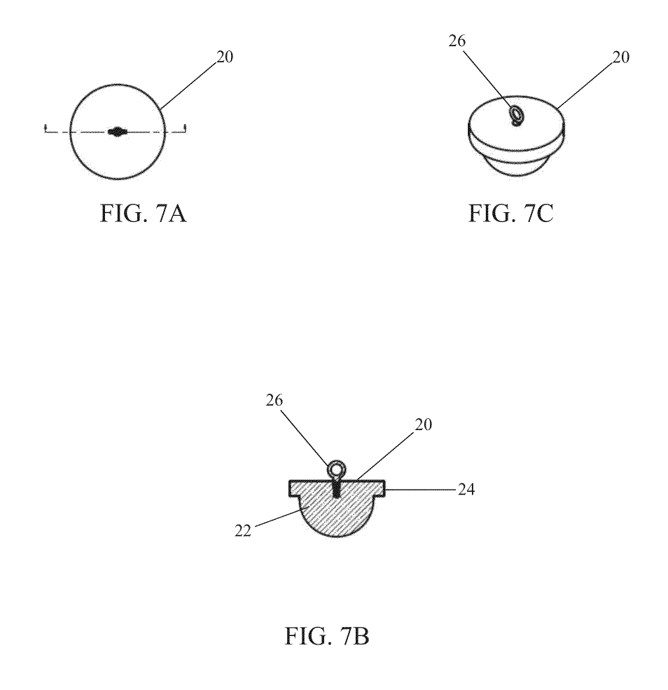

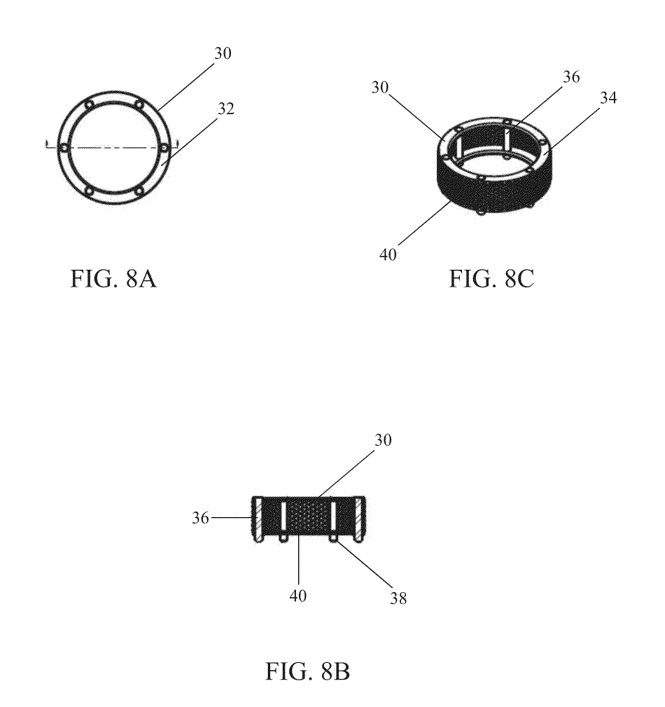

A drain plug assembly 1 of the present invention is illustrated in FIGS. 3-8. FIG. 3 shows the assembly 1 relative to its position in the containment sump, including a plug base 10, a plug 20, and a pedestal 30 having an integral strainer 40. The strainer 40 is an optional feature, but is recommended in order to preclude, or at least minimize, debris transport into the drain line 101. The following discussion assumes that a strainer is present. FIGS. 4A and 4B illustrate assembled plan and cross-section side views, respectively, of a drain plug assembly 1 in the normal (open) position. FIGS. 5A and 5B illustrate assembled plan and cross-section side views, respectively, of a drain plug assembly 1 in the accident (closed) position after the pedestal 30 and the strainer 40 have melted away. FIGS. 6A, 69, and 6C illustrate plan, elevation, and perspective views, respectively, of a base 10 of a drain plug assembly 1 of the present invention. FIGS. 7A, 7B, and 7C illustrate plan, elevation, and perspective views, respectively, of a drain plug 20 of a drain plug assembly 1 of the present invention. FIGS. 8A, 8B, and 8C illustrate plan, elevation, and perspective views, respectively, of a pedestal 30 of a drain plug assembly 1 of the present invention. The drain plug assembly 1 includes a drain plug base 10 and a drain plug 20 supported by a pedestal 30. The pedestal 30 and its integral strainer 40 are formed of a material having a melting temperature within a range that is high enough to withstand temperatures imparted by normal plant operation and abnormal plant conditions, but low enough that it will readily melt during a severe accident when coming into contact with corium. One preferred material is steel. When molten corium comes into contact with the pedestal 30 and strainer 40, they will melt rapidly and the drain plug 20 will drop by gravity into the base 10, effectively closing the sump drain opening and preventing the flow of any significant quantity of corium into the drain.

The base 10 is formed of a material that will not melt at the elevated temperature of the corium. One preferred material is ceramic. In a preferred embodiment, the base 10 includes a hollow cylindrical body with cylindrical exterior and interior surfaces. The exterior surface(s) can be machined as necessary to fit the existing sump configuration so that the base 10 is centered over the plant sump drain line 101. The base 10 may be attached to the plant sump 102 within the plant floor 103 if required; a possible fastener is epoxy adhesive. The sump surfaces should be prepped suitably prior to applying the epoxy. A plurality of circular holes 12 are defined by the base body 10 for locating the pedestal 30, which includes a corresponding number of protuberances 38 configured to matingly engage the pedestal holes.

The drain plug 20 is also formed of a material that will not melt when in contact with the elevated temperature of the molten corium, preferably the same material as the drain base 10. FIGS. 4A and 4B show the drain plug 20 supported above the base 10 by the pedestal 30. The plug includes a spherically shaped region 2.2 that corresponds to and mates with the cylindrical section of the base 10 and the pedestal 30. The plug 20 further includes a cylindrical cap 24 with an embedded lifting ring 26 made of steel to facilitate its installation and positioning on the pedestal 30.

The material selected for the base 10 and plug 20 should have a melting temperature on the order of 3000° C. (approximately 5400° F.), which is approximately 200° C. (360° F.) higher than the expected corium temperature. Materials similar to those used in ‘core-catchers’ for advanced nuclear plant designs may be considered also.

The detailed design for the specific plant in which the drain plug assembly will be used will determine the size (diameter and height) and the optimal configuration of the pedestal 30 to be used. The pedestal 30 includes a support frame 32, which in a preferred embodiment is two horizontally oriented rings 34 attached by vertical bars or rods 36, and a perforated plate or mesh strainer 40 located in the spaces between the vertical members of the pedestal frame. The pedestal 30 performs a number of tasks. It properly supports and retains the plug 20 above the base 10, and it also supports the integral strainer 40. The pedestal 20 thus acts as a fastener between the base 10 and the plug 20. When molten corium at a temperature of between 2400° C. is and 2800° C. comes into contact with the pedestal 30, the pedestal 30 and the strainer 40 melt rapidly and the drain plug 20 will drop by gravity, effectively closing the sump drain opening and preventing the flow of any significant quantity of corium into the drain line 101. The length of the vertical members 36 ensures a sufficient gap between the base 10 and plug 20 to allow an unobstructed flow of fluids therethrough and into the sump drain line 101 during normal plant operation. The vertical members 36 are spaced at uniform intervals on the periphery of the pedestal 30 to allow adequate space for normal leak-off flow, and thus they, in conjunction with the strainer 40, preclude clogging during normal use of the drain line 101.

The pedestal 30 and strainer 40 should preferably be made of a durable, relatively low melting point material such as stainless steel. During a severe accident, both the pedestal 30 and the strainer 40 would melt he they come in contact with the corium. The molten steel from the pedestal 30 and the strainer 40 can be expected to flow into the drain 101 and freeze when it comes into contact with the cooler regions of the drain plug base 10 and the drain line 101. The unlikely condition of the drain plug 20 not seating properly in the ceramic base 10 will be temporary because there will be sufficient thermal energy corium to melt the steel. Furthermore, the shape of the drain plug 20 and the weight of corium above the drain plug 20, together with the weight of the drain plug 20 itself, will be sufficient to ensure that the plug 20 seats properly and prevents corium from entering the drain line 101.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art. will recognize that the invention may be embodied or carried out in a manner that achieves or optimizes one advantage or group of advantages as taught herein without necessarily achieving other advantages as may be taught or suggested herein.

What is claimed is:

1. In a nuclear reactor having a reactor pressure vessel and a sump, a drain plug assembly, comprising:
a base coupled to the sump, said base formed of a ceramic material and defining an interior surface;
a plug formed of a ceramic material and defining an exterior surface configured to matingly engage said base interior surface; and
a fastener interconnecting said base and said plug such that said base and said plug cooperatively define an opening to allow fluid flow therebetween.

2. The drain plug assembly of claim 1, wherein:
said base and said plug are formed of a ceramic material having a melting temperature of over 3000° C.; and
said fastener is formed of a material having a melting temperature with the range of approximately 1300° C. to 1500° C.

3. The drain plug assembly of claim 1, wherein:
said base defines a set of holes therein; and
said fastener includes a set of protuberances positioned within said set of holes.

4. The drain plug assembly of claim 3, wherein:
said base defines a plurality of holes therein; and
said fastener includes a basal ring having a plurality of protuberances extending therefrom, said plurality of protuberances configured to matingly engage said plurality of holes.

5. The drain plug assembly of claim 1, wherein:
said base interior surface has a cylindrical shape; and
said plug exterior surface has a spherical shape configured to matingly engage an upper edge portion of said base interior surface.

6. A nuclear reactor, comprising:
a reactor pressure vessel;
a sump; and
a drain assembly comprising:
a base coupled to the sump, said base formed of a ceramic material and defining an interior surface;
a plug formed of a ceramic material and defining an exterior surface configured to matingly engage said base interior surface; and
a fastener interconnecting said base and said plug such that said base and said plug cooperatively define an opening to allow fluid flow therebetween.

7. The nuclear reactor of claim 6, wherein:
said base and said plug are formed of a ceramic material having a melting temperature of over 3000° C.; and
said fastener is formed of a material having a melting temperature the range of approximately 1300° C. to 1500° C.

8. The nuclear reactor of claim 6, wherein:
said base interior surface has a cylindrical shape; and
said plug exterior surface has a spherical shape configured to matingly engage an upper edge portion of said base interior surface.
